(19) United States
(12) Patent Application Publication
(10) Pub. No.: US 2015/0222479 A1
(43) Pub. Date: Aug. 6, 2015

(54) METHOD OF COMMUNICATING CONTENT IN MOBILE AD-HOC NETWORK AND COMMUNICATION NODE INCLUDED IN MOBILE AD-HOC NETWORK

(71) Applicant: ELECTRONICS AND TELECOMMUNICATIONS RESEARCH INSTITUTE, Daejeon (KR)

(72) Inventors: Jong-Hwan KIM, Daejeon (KR); Il-Gu JUNG, Daejeon (KR); Won RYU, Seoul (KR); Do-Hyung KIM, Daejeon (KR); Ik-Jun YEOM, Suwon-si (KR)

(73) Assignee: ELECTRONICS AND TELECOMMUNICATIONS RESEARCH INSTITUTE, Daejeon (KR)

(21) Appl. No.: 14/591,261

(22) Filed: Jan. 7, 2015

(30) Foreign Application Priority Data
Feb. 4, 2014 (KR) 10-2014-0012660

(51) Int. Cl. H04L 12/24; H04L 12/703; H04L 12/721; H04W 72/00; H04W 28/02

(52) U.S. Cl. CPC H04L 41/0668; H04W 72/005; H04W 28/0236; H04L 45/26; H04L 45/28; H04W 84/18

(57) ABSTRACT

Provided are a method of communicating content in a mobile ad-hoc network and a communication node included in a mobile ad-hoc network, the method and communication node intended to efficiently perform communication based on information centric networking (ICN) in a mobile ad-hoc network and reduce the waste of energy resulting from frequent reconfiguration of communication caused by the mobility of a terminal. The method includes receiving an interest packet or a response packet for content; determining a next node to which the received packet will be relayed based on a forwarding information base (FIB) or a pending interest table (PIT), and relaying the packet using a unicast scheme; and when the relay of the packet to the next node fails, restoring a routing path by storing the packet in a relay candidate buffer and broadcasting the packet.

### CROSS-REFERENCE TO RELATED APPLICATION

This application claims priority to and the benefit of Korean Patent Application No. 10-2014-0012660, filed on Feb. 4, 2014, the disclosure of which is incorporated herein by reference in its entirety.

### BACKGROUND

1. Field of the Invention

Exemplary embodiments relate to a method of communicating content in a mobile ad-hoc network and a communication node included in a mobile ad-hoc network, and more particularly, to an apparatus and method for efficiently performing communication based on information centric networking (ICN) in a mobile ad-hoc network to reduce the waste of energy resulting from frequent reconfiguration of communication caused by the mobility of a terminal.

2. Discussion of Related Art

A mobile ad-hoc network is a distributed network, and does not rely on a pre-existing infrastructure, such as a router or a wireless access point (AP). In the mobile ad-hoc network, each node participates in routing by forwarding data received from other nodes. From an existing general network, the mobile ad-hoc network differs in that, since each node may move, routing is dynamically determined according to network connectivity, and a flooding scheme may be used for forwarding. Due to dynamic and situation-adaptive routing characteristics, the mobile ad-hoc network enables a rapid and simple network setup, and may be applied for communication between wireless terminals or sensors when no wireless infrastructure has been set in advance.

On the other hand, due to the characteristics of mobile nodes, there are limited resources, such as wireless transmission power, central processing units (CPUs), and memories, and network failures frequently occur. In addition, the flooding scheme for relaying packets to all surrounding nodes is energy inefficient because all nodes relay a packet and packet duplication may occur. Furthermore, since radio resources are shared by all nodes, the nodes compete for the radio resources, and there may be a collision for or interference with access to a wireless medium. Meanwhile, according to ICN, a terminal requests content by using the name of the content instead of an existing host Internet protocol (IP) method of requesting the content by using the address of a host having the content, and receives the content from a node on a routing path when the node has a cache of the content. Therefore, ICN is attracting attention as an efficient communication method.

### SUMMARY OF THE INVENTION

Exemplary embodiments are directed to an apparatus and method for efficiently performing communication based on information centric networking (ICN) to reduce the waste of energy resulting from frequent reconfiguration of communication caused by the mobility of a mobile terminal when the mobile terminal performs content communication in a mobile ad-hoc network.

Exemplary embodiments are also directed to a communication apparatus and method that make it possible to rapidly restore a routing path by ICN when content communication of a mobile terminal in a mobile ad-hoc network is cut off due to movement of the terminal present on the previously set routing path.

Illustrative, non-limiting embodiments may overcome the above disadvantages and other disadvantages not described above. The present invention is not necessarily required to overcome any of the disadvantages described above, and the illustrative, non-limiting embodiments may not overcome any of the problems described above. The appended claims should be consulted to ascertain the true scope of the invention.

According to an aspect of exemplary embodiments, there is provided a method of communicating content in a mobile ad-hoc network. The method includes: receiving an interest packet or a response packet for content; determining a next node to which the received packet will be relayed based on a forwarding information base (FIB) or a pending interest table (PIT), and relaying the packet using a unicast scheme; and when the relay of the packet to the next node fails, restoring a routing path by storing the packet in a relay candidate buffer and broadcasting the packet.

According to an exemplary embodiment, a header of the packet may include at least one of requestor identification information, identification information of a relay node having relayed the packet, a distance from a requestor, a packet lifetime, a content identifier (ID), and a flooding bit.

According to an exemplary embodiment, the FIB may store routing path information of content-specific interest packets as a table, and each entry may include at least one of a content ID, identification information of a next node to which the packet will be relayed, a distance from a content provider, and lifetime information of the entry.

According to an exemplary embodiment, the PIT may store information on an interest packet waiting for a response packet as a table, and each entry may include at least one of a content ID, requestor identification information, information on a relay node having relayed the interest packet, information on a distance from a requestor, lifetime information of the entry, and a flooding bit.

According to an exemplary embodiment, the determination of the next node to which the received packet will be relayed may include: determining the next node based on the FIB when the received packet is the interest packet; and determining the next node based on the PIT when the received packet is the response packet.

According to an exemplary embodiment, the restoring of the routing path may include: searching the relay candidate buffer for a response packet corresponding to the interest packet when the packet having failed to be relayed is the interest packet, and searching the relay candidate buffer for an interest packet corresponding to the response packet when the packet having failed to be relayed is the response packet; when the corresponding response packet or interest packet is retrieved, determining a next node to which the packet, having failed to be relayed, will be relayed based on header information of the retrieved packet, and retransmitting the packet; and removing the retransmitted packet from the relay candidate buffer.

According to an exemplary embodiment, the restoring of the routing path may further include: determining a next node to which the interest or response packet retrieved to correspond to the packet, having failed to be relayed, will be relayed based on header information of the packet having failed to be relayed, and retransmitting the corresponding packet and removing the retransmitted corresponding packet from the relay candidate buffer.

According to an exemplary embodiment, the searching of the corresponding response packet or interest packet may include searching for a packet including the same content ID as the packet having failed to be relayed in a header.

According to another aspect of the present invention, there is provided a method of communicating content in a mobile ad-hoc network. The method includes: receiving an interest packet for content; determining whether content corresponding to a content ID included in a header of the interest packet is present in a content memory; when it is determined that the content corresponding to the content ID is not present in the content memory, updating a PIT based on header information of the interest packet; updating relay node identification information in the header information of the interest packet with identification information of a current node having received the interest packet, and increasing a value of distance from a requestor; determining a next node to which the interest packet will be relayed based on an FIB, and relaying the interest packet; and when the relay of the interest packet to the next node fails, restoring a routing path by storing the interest packet in a relay candidate buffer and broadcasting the interest packet.

According to an exemplary embodiment, the method may further include, when it is determined that the content corresponding to the content ID included in the header of the interest packet is present in the content memory, generating a response packet including the content present in the content memory and returning the response packet to a node having relayed the interest packet.

According to an exemplary embodiment, a header of the interest packet may include at least one of requestor identification information, identification information of a relay node having relayed the interest packet, the distance from the requestor, a packet lifetime, a content ID, and a flooding bit.

According to an exemplary embodiment, each entry of the PIT may include at least one of a content ID, content requestor identification information, identification information of a relay node having relayed the interest packet for requesting the content, information on the distance from the requestor, lifetime information of the entry, and a flooding bit.

According to an exemplary embodiment, the updating of the PIT based on the header information of the interest packet may include: when there is no entry having the same requestor identification information and content ID as the interest packet, adding an entry corresponding to the interest packet to the PIT based on the header information of the interest packet; and when there is an entry having the same requestor identification information and content ID as the interest packet but the distance value stored in the interest packet is smaller than a distance value of the entry in the PIT, updating the entry with the header information of the interest packet.

According to an exemplary embodiment, the restoring of the routing path may include: searching the relay candidate buffer for a response packet corresponding to the interest packet having failed to be relayed; when the corresponding response packet is retrieved, determining a next node to which the interest packet, having failed to be relayed, will be relayed based on header information of the retrieved response packet, and retransmitting the interest packet having failed to be relayed; determining a next node to which the retrieved response packet will be relayed based on the header information of the interest packet having failed to be relayed, and retransmitting the retrieved response packet; and removing the retransmitted interest and response packets from the relay candidate buffer.

According to yet another aspect of an exemplary embodiment, there is provided a method of communicating content in a mobile ad-hoc network. The method includes: receiving a response packet including content; storing the content included in the response packet in a content memory together with a content ID; updating relay node identification information in header information of the response packet with identification information of a current node, and increasing a value of distance from a requestor; determining a next node to which the response packet will be relayed based on a PIT, and relaying the response packet; and when the determination of the next node fails or the relay of the response packet to the next node fails, restoring a routing path by storing the response packet in a relay candidate buffer and broadcasting the response packet.

According to an exemplary embodiment, the restoring of the routing path may include: searching the relay candidate buffer for an interest packet corresponding to the response packet having failed to be relayed; determining a next node to which the response packet, having failed to be relayed, will be relayed based on header information of a retrieved interest packet, and retransmitting the response packet having failed to be relayed; determining a next node to which the retrieved interest packet will be relayed based on the header information of the response packet having failed to be relayed, and retransmitting the retrieved interest packet; and removing the retransmitted response and interest packets from the relay candidate buffer.

According to an exemplary embodiment, the method may further include, after the relay of the response packet is finished, removing an entry of an interest packet corresponding to the response packet from the PIT.

According to an exemplary embodiment, the method may further include adding or updating an entry in an FIB based on the header information of the response packet.

According to yet another aspect of an exemplary embodiment, there is provided a communication node included in a mobile ad-hoc network, the communication node including: a wireless transceiver configured to exchange packets with a neighboring node; a processor; and a memory comprising instructions that, when executed by the processor; perform operations comprising: receiving an interest packet for content or a response packet including content from the neighboring node through the wireless transceiver; determining a next node to which the received packet will be relayed based on a forwarding information base (FIB) or a pending interest table (PIT) stored in the memory to relay the received packet; and restoring a routing path by storing the received packet in a relay candidate buffer in the memory and broadcasting the received packet through the wireless transceiver, when the relay of the received packet to the next node fails.

According to yet another aspect of an exemplary embodiment, there is provided a communication node included in a mobile ad-hoc network, the communication node including: a wireless transceiver configured to exchange packets with a neighboring node; a processor; and a memory comprising instructions that, when executed by the processor; perform operations comprising: receiving an interest packet for content from the neighboring node through the wireless transceiver; determining whether content corresponding to a content identifier (ID) included in a header of the interest packet is present in the memory; updating a pending interest table (PIT) in the memory based on header information of the interest packet, updating relay node identification information in the header information of the interest packet with identification information of the communication node, increasing a value of distance from a requestor, and determining a next node to which the interest packet will be relayed based on a forwarding information base (FIB) in the memory, when it is determined that the content corresponding to the content ID is not present in the memory; and restoring a routing path by storing the interest packet in a relay candidate buffer in the memory and broadcasting the interest packet, when relay of the interest packet to the determined next node fails.

According to yet another aspect of an exemplary embodiment, there is provided a communication node included in a mobile ad-hoc network, the communication node including: a wireless transceiver configured to exchange packets with a neighboring node; a processor; and a memory comprising instructions that, when executed by the processor; perform operations comprising: receiving a response packet including content from the neighboring node through the wireless transceiver; storing the content included in the response packet in the memory together with a content identifier (ID); updating relay node identification information in header information of the response packet with identification information of the communication node and increasing a value of distance from a requestor, determining a next node to which the response packet will be relayed based on a pending interest table (PIT) in the memory and relaying the response packet; and restoring a routing path by storing the response packet in a relay candidate buffer in the memory and broadcasting the response packet, when the determination of the next node fails or the relay of the response packet to the determined next node fails.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a conceptual diagram showing a process of requesting content according to content-centric networking (CCN);

FIG. 2 is a diagram of a process in which a node broadcasts a content request packet around itself to request content;

FIG. 3 is a diagram showing a situation in which communication is cut off in a mobile ad-hoc network;

FIG. 4 is a flowchart illustrating a content communication process of a communication node in a mobile ad-hoc network according to an exemplary embodiment of the present invention;

FIG. 5 is a flowchart illustrating a process of restoring a routing path in a mobile ad-hoc network according to an exemplary embodiment of the present invention;

FIG. 6 is a diagram schematically showing a process of establishing an initial routing path between a content requestor and a content provider;

FIG. 7 is a flowchart illustrating a process of relaying a content request packet according to another exemplary embodiment of the present invention in detail;

FIG. 8 is a flowchart illustrating a process of returning a response packet including content according to another exemplary embodiment of the present invention in detail; and

FIG. 9 is a block diagram of a communication node performing content communication according to another exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications may be made without departing from the spirit and scope of the invention.

In the description of the present invention, when it is determined that a detailed description of the related art of the invention unnecessarily obscures the gist of the invention, the detailed description will be omitted.

As used herein, the singular forms “a,” “an,” and “the” are intended to include the plural forms as well, unless the context clearly indicates otherwise.

Among terms used in this specification, “module,” “unit,” “interface,” etc. generally denote computer-related objects, for example, hardware, software, and a combination of hardware and software.

First, the terms mentioned in this specification will be described.

Interest packet: This is a content request message and may include routing-related information in its header.

Pending Interest Table (PIT): This is prepared in each communication node to store information on interest packets waiting for response packets. When a plurality of interest packets for the same content are received from the same requestor, only an interest packet having a short distance from the requestor may be kept in a PIT. A PIT is used to determine a routing path of a response packet corresponding to an interest packet, and when a response packet corresponding to an interest packet is received, an entry corresponding to the interest packet is removed from a PIT.

Forwarding Information Base (FIB): This is prepared in each communication node and is a table for storing routing path information of a subsequent interest packet for the same content. Routing path information (i.e., a next hop) may be set in an FIB using header information of a response packet.

Prior to the description of an embodiment of the present invention, in order to aid in understanding the present invention, the concept of information centric networking (ICN) and a broadcast-based packet relay method in a mobile ad-hoc network will be described below.

ICN is a communication architecture in which a terminal requests content by using the name of the content instead of an existing host Internet protocol (IP) method of requesting the content by using the address of a host having the content, and receives the content from a node on a routing path when the node has a cache of the content.

A basic tutorial about ICN may be consulted in “A Survey of Information-Centric Networking” published in July 2012 in the Institute of Electrical and Electronics Engineers (IEEE) Communication magazine. According to the tutorial, in an existing IP network, content is requested by using the address of a server host, such as ftp://123.211.222.112/movie127.avi, and a content name. Representative of such methods is a file transfer protocol (FTP) method as shown in the address of the above example. Such methods involve always acquiring content from the corresponding host server. To solve this problem, in ICN, a content request is made using a content name instead of a content host address. For example, “Get movie127.avi” is used. When such a method is used, it is possible to acquire content from a cache server having the file “movie127.avi” without relaying a request message to a host server. Therefore, the content may be rapidly acquired, and also network load may be reduced. Such a method is similar to a combination of a method of searching for content with a content name and readily acquiring the content from a close node using an existing peer-to-peer (P2P) application and a hypertext transfer protocol (HTTP)-based method of requesting content using a Representational State Transfer (REST) technique and facilitating content distribution by preparing a memory cache server on a routing path.

Such ICN may be implemented in various ways, and a typical example is content-centric networking (CCN). A detailed example of CCN is as follows. When a content request is made according to CCN, a request message for requesting content is referred to as an “interest message,” and a data name that is a content name may have a hierarchical structure, such as “/Domain/dhkim/File.” For example, when file-x of dhkim in Etri is wanted, an interest message is transmitted to a gateway server. At this time, the corresponding interest message packet includes content of requesting “Etri/dhkim/file-x.” The interest message is propagated around the corresponding node through a routing server according to a hop-by-hop routing algorithm.

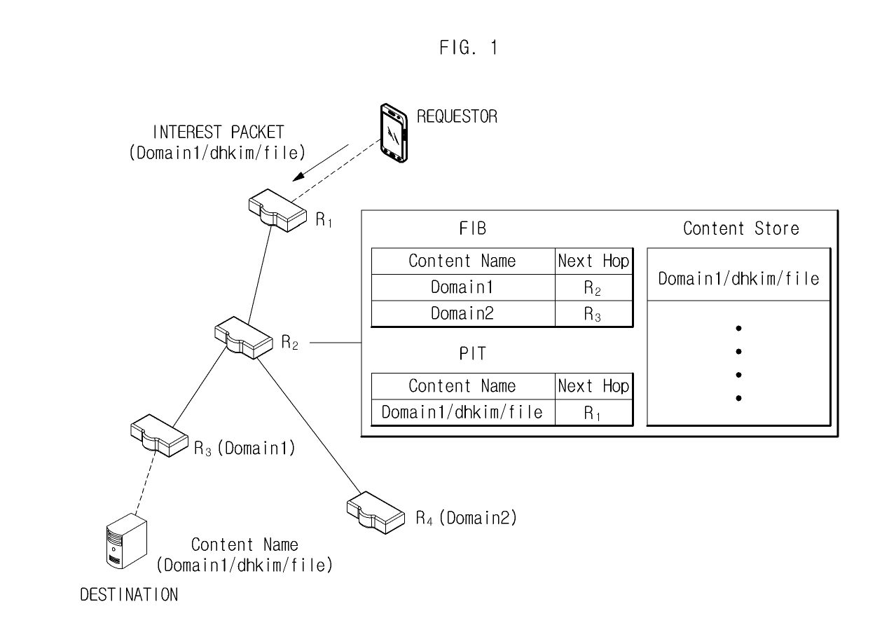

FIG. 1 is a conceptual diagram showing a process of requesting content according to CCN.

FIG. 1 shows a process of a requestor relaying an interest packet for requesting content “Dmainl/dhkim/file.” The interest packet arrives at a destination through intermediate nodes R1, R2, and R3 and causes downloading of the content. At this time, the intermediate nodes perform routing using domain information included in the interest packet based on a routing table called FIB as shown in FIG. 1, and a content name and relay node information included in the interest packet is recorded in a PIT so that the content name and the relay node information may be consulted when a response packet is returned later.

When the interest packet is propagated and arrives at a destination server having the content, the server generates a response packet for the content and returns the response packet to the requestor. At this time, the intermediate nodes, through which the response packet is relayed, cache data included in the response packet in their local storages called content stores as occasion demands, and when a request for the content is received thereafter, the intermediate nodes immediately respond to the request. For this reason, content that is frequently requested by users is highly likely to be cached in intermediate routers present in a network and thus may be rapidly acquired from intermediate nodes instead of an original source server. Therefore, network load is reduced, and also users may rapidly download content.

In particular, such a method is mainly used in CCN among many implemental forms of ICN. Such a method may slightly vary according to the implemental form, and the currently proposed method may also be modified. Those of ordinary skill in the art will appreciate that the present invention is not limited to the implemental form described above.

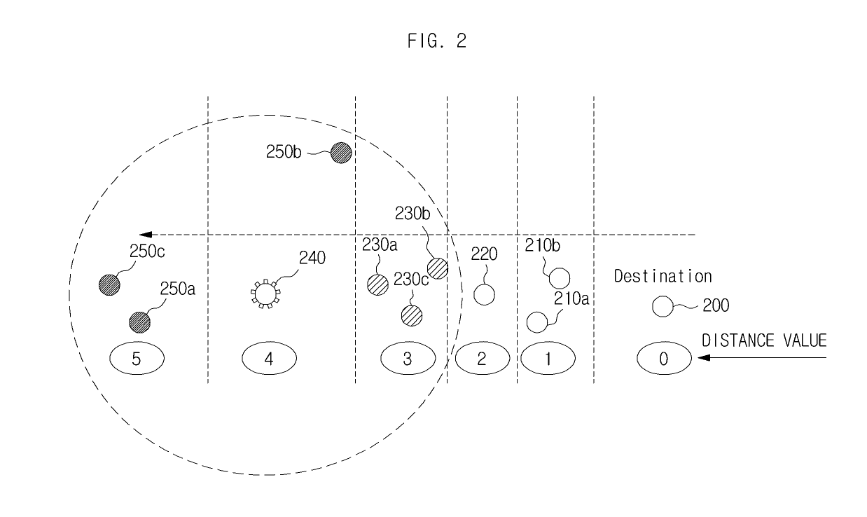

With reference to FIG. 2, a broadcast-based packet relay method in a mobile ad-hoc network will be described below.

Listen First, Broadcast Later (LFBL) is a typical broadcast-based packet relay method in a mobile ad-hoc network. LFBL is described in detail in “Listen First, Broadcast Later: topology-agnostic forwarding under high dynamics” (M. Meisel, V. Pappas, L. Zhang, Proceedings of the Annual Conference of International Technology Alliance in Network and Information Science, London, UK, 2010). According to the LFBL method, to support dynamic mobility of mobile communication nodes, an end-to-end routing path is not maintained, but each node performs broadcasting around itself based on its routing information. To determine whether or not to broadcast a received packet around each node, the node monitors packet communication around itself and maintains a distance table.

FIG. 2 is a diagram of a process in which a node broadcasts a content request packet around itself to request content. As shown in the drawing, a node 200, indicated as a destination, broadcasts a content request packet to request content. At this time, the header of the request packet includes a sequence number seqnum (assigned by a source node and sequentially increasing), an acknowledgement number acknum (accumulated acknowledgement number set by the source node), a source identifier (ID) srcId (source node ID determined according to a media access control (MAC) address), a destination ID dstId, a source distance srcDist (distance between the source node and the most recent relay node, changed at each hop), a destination distance dstDist (distance between the most recent relay node and a destination node, changed at each hop), an LFBL message type type (request REQ, response REP, acknowledgement ACK, or a combined acknowledgement and request ACK+REQ), and a data name dataName (requested or provided data name). For example, seqnum is set to 0, srcId is set to the node ID of the node 200, srcDist is set to 0, type is set to REQ, and dataName is set to a content ID. Other unknown information is not set or set to 0. Each node receiving the request packet increases seqnum by 1, updates srcDist by adding a distance (for convenience, 1 may be used as a distance value between nodes) from the node 200, which has just sent the packet to the node, to srcDist, stores {scrId, srcDist} information in a local table, and then broadcast the request packet again. When the content request packet is broadcast in this way, the packet finally arrives at a node having the content. As shown in FIG. 2, a distance value sequentially increases as a node receiving the request packet is further away from the node 200 having transmitted the request packet.

Assuming that, in FIG. 2, a node 240 at a distance of 4 has the content, the node 240 transmits a response packet corresponding to the request packet. In the header of the response packet, type is set to REP, dstId is set to the ID of the node 200 (the ID may be obtained from srcId of the request packet), and dstDist is set to 4, which may be checked from a {scrId, srcDist} information table that contains information calculated by the node 240.

Referring to FIG. 2, when the node 240 broadcasts the response packet around itself, nodes 230a, 230b, and 230c and black nodes 250a and 250b may receive the response packet. Here, the nodes 230a, 230b, and 230c are at a distance of 3 from dstId of the response packet. In other words, only the nodes 230a, 230b, and 230c are at a shorter distance of 3 from the destination node 200 than the node 240, and thus have rights to additionally broadcast the response packet. At this time, the nodes 230a, 230b, and 230c, except for a node that first performs broadcasting in response, perform no operation. When forwarding relay of the response packet is repeated in this way, the response packet may be eventually relayed to the destination node 200.

According to this method, an end-to-end routing path is not maintained, but each node automatically responds based on distance information. Therefore, this method is simple and rapidly adapted for movement of a mobile terminal, thus facilitating restoration. On the other hand, all packets are broadcast, and all nodes receiving the corresponding packet make a calculation for and a response to the received packet. Therefore, this method has high energy consumption.

To solve this problem, exemplary embodiments of the present invention focus on a method of basically performing unicast-based communication, in which a packet is forwarded to a single next hop node based on set routing path information, and rapidly restoring a set routing path based on ICN when communication is cut off due to movement of a terminal on the routing path. It is assumed that an arbitrary existing method is employed as a method of establishing an initial routing path.

To reduce the waste of energy resulting from frequent reconfiguration of communication caused by the mobility of a mobile terminal when the communication is performed to exchange content between mobile terminals in a mobile ad-hoc network, an exemplary embodiment of the present invention proposes a method of requesting content using a content name and routing a packet based on all ICN architectures, in which an intermediate network node caches the content, in a mobile ad-hoc network.

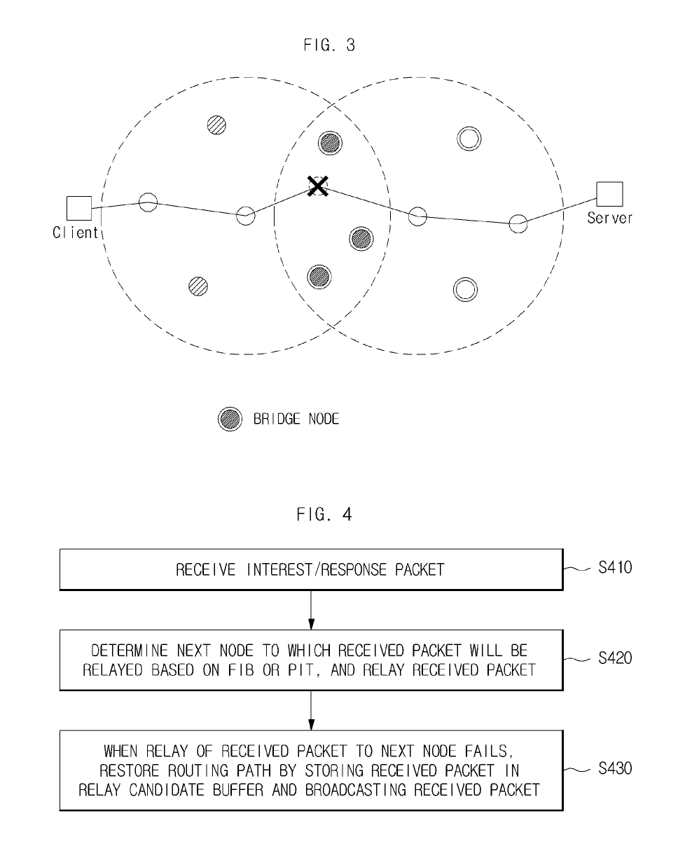

An exemplary embodiment of the present invention will be described in detail below with reference to FIGS. 3 to 9.

FIG. 3 is a diagram showing a situation in which communication is cut off in a mobile ad-hoc network. As shown in the drawing, when a node X moves and disappears while a client and a server are communicating with each other through nodes connected along a line and set as a routing path, the communication is cut off. At this time, a node A tries to transmit an interest packet from the client to the node X but fails, and broadcasts the interest packet around itself. When no acknowledgement is received for a predetermined time, it may be determined that the transmission has failed. Likewise, a node B tries to transmit a response packet from the server to the node X but fails, and broadcasts the response packet around itself. In this case, intermediate nodes between the node A and the node B may receive both the interest packet and the response packet.

According to an exemplary embodiment of the present invention, nodes that receive both interest and response packets for the same content recognize themselves as bridge nodes, and transmit the interest and response packets in opposite directions, so that a routing path is restored.

In an exemplary embodiment, to overcome a difference in broadcast time between an interest packet and a response packet and facilitate restoration of a routing path, nodes may cache interest/response packets having failed to be routed in a local relay candidate buffer for a predetermined time. In addition, to avoid a collision between bridge nodes, a connection restoration response may be processed when no node makes a response after a random time before packet relay.

In other words, in order for nodes having an ICN function to efficiently use energy in a mobile ad-hoc network, an exemplary embodiment of the present invention proposes a communication method of basically performing unicast-based packet transmission and reception and restoring a routing path based on 1-hop broadcasting when the routing path is cut off due to movement of a terminal, etc.

FIG. 4 is a flowchart illustrating a content communication process of a communication node in a mobile ad-hoc network according to an exemplary embodiment of the present invention.

In step 410, a communication node receives an interest packet for content or a response packet including content.

In an exemplary embodiment, header information of an interest/response packet includes at least one of requestor identification information, identification information of a relay node having just relayed the packet, a distance from a requestor, a packet lifetime, a content ID, and a flooding bit.

In an exemplary embodiment, the lifetime of an entry related to the corresponding packet in a FIB or a PIT may be set according to the packet lifetime information.

In an exemplary embodiment, the content ID may include a content name and a chunk ID.

In an exemplary embodiment, the flooding bit indicates whether or not to flood the corresponding packet. When a requestor initially makes a content request, there is no routing path information. Therefore, a flooding bit is set to 1, and the corresponding interest packet is flooded. After a routing path is established by returning a response packet corresponding to the flooded interest packet, the flooding bit is set to 0.

In step 420, the communication node receiving the interest/response packet determines a next node to which the received packet will be relayed based on the FIB or the PIT and relays the packet. At this time, the communication node updates the relay node identification information and information on the distance from the requestor in the header information of the packet to be relayed. The communication node stores its identification information as relay node identification information, and increases a distance value by 1.

In an exemplary embodiment, a packet is relayed using the unicast scheme.

In an exemplary embodiment, an FIB stores routing path information of content-specific interest packets as a table, and each entry of the FIB may include at least one of a content ID, identification information of a next node to which an interest packet for requesting the corresponding content will be relayed, a distance from a content provider, and lifetime information of the entry.

In an exemplary embodiment, the initial path of an interest packet in a mobile ad-hoc network may be set using various well-known routing techniques, and path information may be stored in the FIB of each node included in the set path.

In an exemplary embodiment, a PIT stores information on an interest packet waiting for a response packet as a table, and may be used as path information of the response packet corresponding to the interest packet. Each entry of a PIT may include at least one of a content ID, requestor identification information, information on a relay node having relayed the interest packet for requesting the corresponding content, information on a distance from the requestor, lifetime information of the entry, and a flooding bit.

In step 430, when the relay of the packet to the next node fails, the node restores a routing path by storing the packet in a relay candidate buffer and broadcasting the packet.

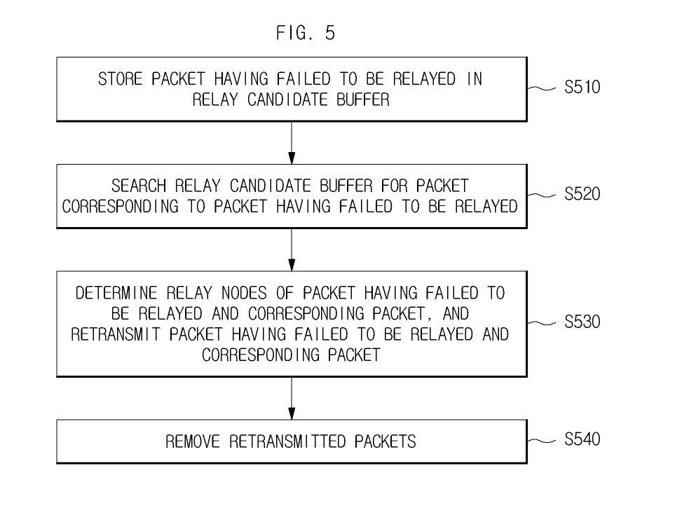

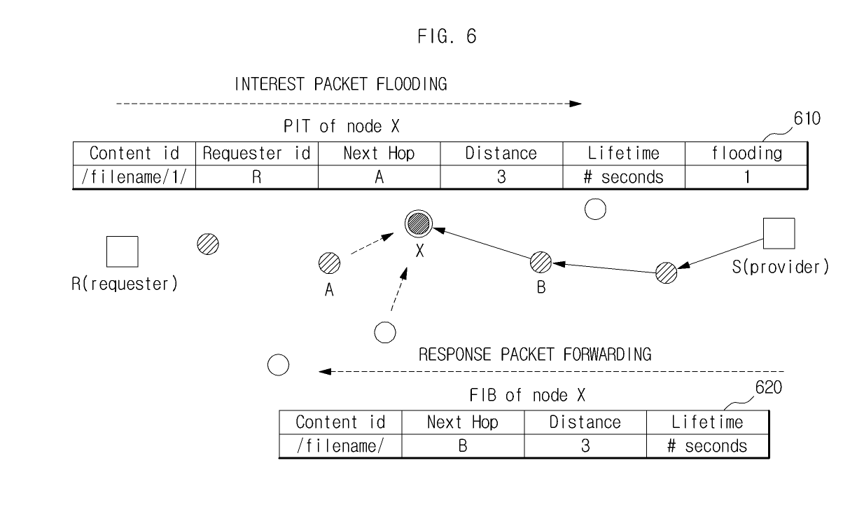

FIG. 5 is a flowchart illustrating a process of restoring a routing path in a mobile ad-hoc network according to an exemplary embodiment of the present invention.

In step 510, a packet having failed to be relayed is stored in a relay candidate buffer.

In step 520, when the packet having failed to be relayed is an interest packet, the relay candidate buffer is searched for a response packet corresponding to the interest packet, and when the packet having failed to be relayed is a response packet, the relay candidate buffer is searched for an interest packet corresponding to the response packet. In an exemplary embodiment, the corresponding packet may denote a packet including the same content ID as the packet having failed to be relayed in its header.

In step 530, a next node to which the packet, having failed to be relayed, will be relayed is determined based on header information of a retrieved packet, and the packet is relayed again. In addition, a next node to which the corresponding packet will be relayed may be determined based on header information of the packet having failed to be relayed.

For example, when the packet having failed to be relayed is an interest packet, the interest packet is relayed to a node having just transmitted the response packet corresponding to the packet, and the response packet is relayed to a node having just transmitted the interest packet, so that a routing path may be restored.

In step 540, the transmitted interest and response packets are removed from the relay candidate buffer.

FIG. 6 is a diagram schematically showing a process of establishing an initial routing path between a content requestor and a content provider.

As shown in FIG. 6, when a content requestor R and a content provider S communicate with each other, PIT information maintained by a node X is a PIT 610. The content requestor R requests content called chunk number 1 of filename, and the node X relays the corresponding interest packet. In this situation, the node X stores information indicating a node A that has just relayed the interest packet in a next hop field among PIT entries, calculates a distance from the content requestor R to the node X to be 3, and stores the distance value in a distance field. A lifetime is information for preventing an interest packet from infinitely existing in a PIT, and when the lifetime expires, the corresponding entry is automatically removed. A requestor may set a lifetime to an arbitrary value.

When the requestor R initially makes a content request, there is no routing path, and thus flooding of the interest packet is started like an LFBL-based routing path establishment process. At this time, in the header of the interest packet, a flooding bit is set to 1. After routing path is established, the flooding bit is set to 0.

During a process in which the initial interest packet is relayed to the destination S hop by hop using a flooding scheme, each intermediate node may receive a plurality of interest packets. At this time, each intermediate node maintains PIT entries based on an interest packet whose distance value is calculated to be the smallest. For this reason, when a response packet is transmitted in a reverse direction from the destination S to the requestor R based on PITs, the response packet returns through hops having smaller distance values than previous hops, and thus it is possible to achieve a similar performance with the shortest path.

An FIB 620 of the node X shown in FIG. 6 is information set for routing a subsequent interest packet when a response packet returns. In other words, the node X stores nodes having just relayed response packets for pieces of content according to content IDs (B in the case of X), and stores a value of distance from the provider S in a distance field.

In brief, an initial interest packet is basically transmitted to a destination by broadcasting, and at this time, a routing path through which a response packet may be relayed in a reverse direction is established based on PIT entries generated in respective nodes. Also, when the response packet is relayed in the reverse direction, information on nodes having relayed the response packet are added as entries in FIBs, and thus subsequent interest packets are not broadcast but are transmitted based on the FIBs using the unicast scheme. Since a request for content called filename is made by dividing the content into a plurality of chunks, such as filename/1, filename/2, . . . , a prefix of each piece of content is recorded in a content id field of a FIB to forward the content based on the FIB using longest prefix matching.

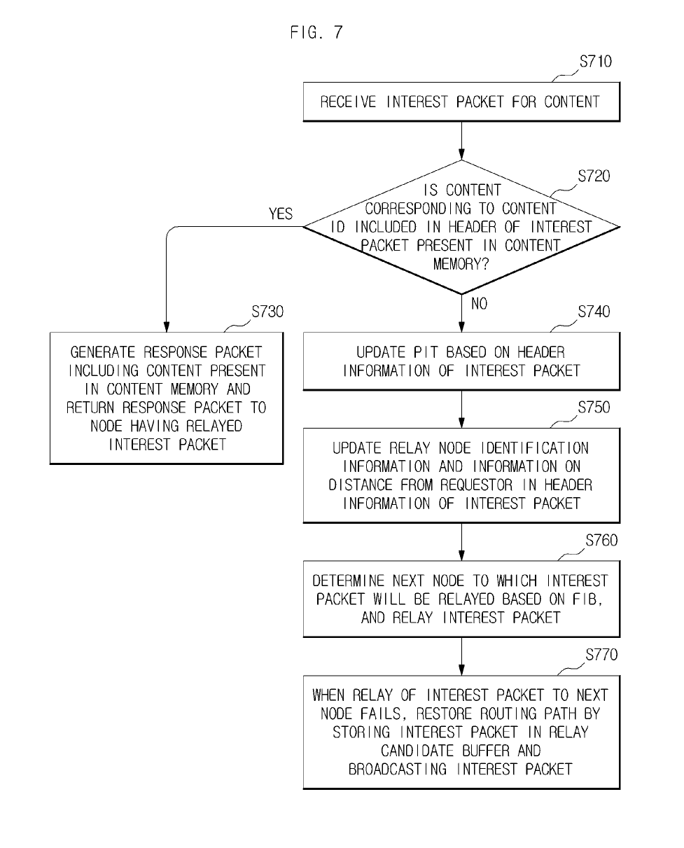

FIG. 7 is a flowchart illustrating a process of relaying a content request packet according to an exemplary embodiment of the present invention in detail.

In step 710, an interest packet for content is received.

In an exemplary embodiment, the header of the interest packet may include at least one of requestor identification information, identification information of a relay node having relayed the packet, a distance from a requestor, a packet lifetime, a content ID, and a flooding bit.

When it is determined that the content is present in a content memory, a response packet including the content present in the content memory is generated and returned to the node having relayed the interest packet (S730), and then relay of the interest packet is finished.

On the other hand, when it is determined that the content is not present in the content memory, a PIT is updated based on the header information of the interest packet (S740).

In an exemplary embodiment, each entry of the PIT is identified by a content ID and requestor identification information, and may include at least one of a content ID, content requestor identification information, identification information of a relay node having relayed the interest packet for requesting the content, information on the distance from the requestor, lifetime information of the entry, and a flooding bit.

In an exemplary embodiment, when there is no entry having the same requestor identification information and content ID as the interest packet in the PIT, the PIT is updated by adding an entry corresponding to the interest packet based on the header information of the interest packet.

On the other hand, when there is an entry having the same requestor identification information and content ID as the interest packet but a distance value of the entry in the PIT is larger than the distance value stored in the interest packet, the entry is updated with the header information of the interest packet.

Next, the relay node identification information in the header information of the interest packet is updated with the identification information of a current node having received the interest packet, and a value of distance from the requestor is increased by 1 (S750).

Next, a next node to which the interest packet will be relayed is determined based on an FIB, and the interest packet is relayed to a next node (S760).

When the relay of the interest packet to the next node fails, a routing path is restored by storing the interest packet in a relay candidate buffer and broadcasting the interest packet (S770).

As described above with reference to FIG. 5, restoration of a routing path involves a process of searching a relay candidate buffer for a response packet corresponding to an interest packet having failed to be relayed, determining a next hop (node) to which the interest packet, having failed to be relayed, will be relayed based on header information of the response packet, retransmitting the interest packet having failed to be relayed, and removing the retransmitted interest packet from the relay candidate buffer. Also, the retrieved response packet is retransmitted by determining a next hop (node) based on the header information of the interest packet, and then removed from the relay candidate buffer.

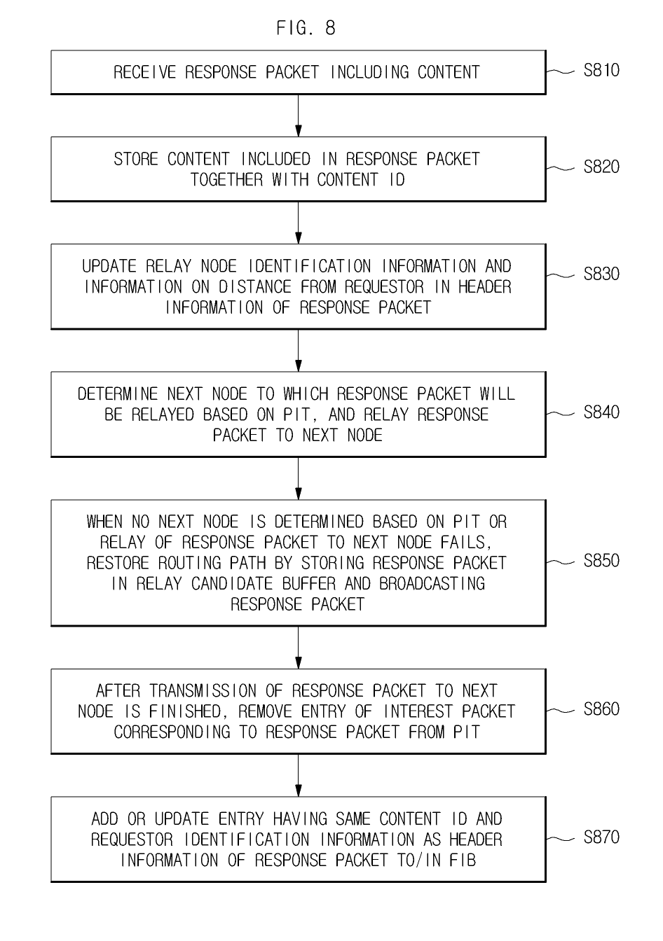

FIG. 8 is a flowchart illustrating a process of returning a response packet including content according to an exemplary embodiment of the present invention in detail.

In step 810, a response packet including content is received.

In step 820, the content included in the response packet is stored in a content memory together with a content ID.

In step 830, relay node identification information in header information of the response packet is updated with identification information of a current node, and a value of distance from a requestor is increased by 1.

In step 840, a next node to which the response packet will be relayed is determined based on a PIT, and the response packet is relayed to the next node.

In step 850, when no next node is determined based on the PIT or the relay of the response packet to the next node fails, a routing path is restored by storing the response packet in a relay candidate buffer and broadcasting the response packet.

The routing path restoration is performed similar to the routing path restoration process of FIG. 7 performed when the relay of an interest packet fails.

In step 860, after transmission of the response packet to the next node is finished, the entry of an interest packet corresponding to the response packet is removed from the PIT.

In step 870, an entry corresponding to the same content ID and requestor identification information as the header information of the response packet may be added to or updated in an FIB.

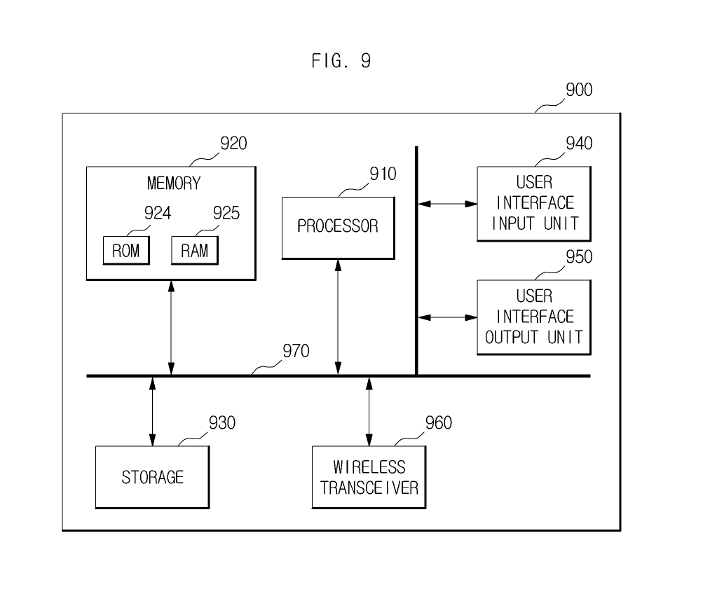

FIG. 9 is a block diagram of a communication node performing content communication according to an exemplary embodiment of the present invention.

As shown in the drawing, similarly to a general-use computer system, a communication node 900 may include one or more components from at least one processor 910, a memory 920, a storage 930, a user interface input unit 940, a user interface output unit 950, and a wireless transceiver 960, and these components may communicate with each other via a bus 970.

The processor 910 may be a central processing unit (CPU) or a semiconductor device that executes a processing instruction stored in the memory 920 and/or the storage 930. The memory 920 and the storage 930 may include various types of volatile/non-volatile storage media. For example, the memory 920 may include a ROM 924 and a RAM 925.

The methods of communicating content according to the exemplary embodiments of the present invention may be implemented in the form of computer-executable instructions and stored in the memory 920 and/or the storage 930, and may be performed when the instructions are executed by the processor 910.

Meanwhile, an apparatus and method according to exemplary embodiments of the present invention may be implemented in the form of program commands that may be executed by various computing means and recorded in a computer-readable recording medium. The computer-readable recording medium may include a program command, a local data file, a data structure, etc., solely or in a combined manner.

The program command recorded in the computer-readable recording medium may be specially designed and configured for the present invention, or known and available to those of ordinary skill in the field of computer software. Examples of the computer-readable recording medium include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and execute program commands. The above-described medium may be light including a carrier wave for transmitting a signal indicating a program command, a data structure, etc., or a transmission medium, such as a metal wire or a waveguide. Examples of the program commands may include high-level language codes executable by a computer using an interpreter, etc., as well as machine language codes made by compilers.

According to an exemplary embodiment of the present invention, communication between mobile terminals in a mobile ad-hoc network is basically performed not using the broadcast scheme but using the unicast scheme, and when the communication is cut off due to movement of a terminal, the communication is simply restored using the broadcast scheme around the corresponding node only. Therefore, the communication method is very efficient in energy saving.

According to an exemplary embodiment of the present invention, even when communication is cut off in a mobile ad-hoc network due to the mobility of a terminal, a cut routing path can be rapidly restored with as small as possible number of control packets. Therefore, energy consumption is effectively reduced.

It will be apparent to those skilled in the art that various modifications may be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of communicating content in a mobile ad-hoc network, the method comprising:
receiving an interest packet or a response packet for content;
determining a next node to which the received packet will be relayed based on a forwarding information base (FIB) or a pending interest table (PIT), and relaying the packet using a unicast scheme; and
when the relay of the packet to the next node fails, restoring a routing path by storing the packet in a relay candidate buffer and broadcasting the packet.

2. The method of claim 1, wherein a header of the packet includes at least one of requestor identification information, identification information of a relay node having relayed the packet, a distance from a requestor, a packet lifetime, a content identifier (ID), and a flooding bit.

3. The method of claim 1, wherein the FIB stores routing path information of content-specific interest packets as a table, and
each entry includes at least one of a content identifier (ID), identification information of a next node to which the packet will be relayed, a distance from a content provider, and lifetime information of the entry.

4. The method of claim 1, wherein the PIT stores information on an interest packet waiting for a response packet as a table, and
each entry includes at least one of a content identifier (ID), requestor identification information, information on a relay node having relayed the interest packet, information on a distance from a requestor, lifetime information of the entry, and a flooding bit.

5. The method of claim 1, wherein the determination of the next node to which the received packet will be relayed includes:
determining the next node based on the FIB when the received packet is the interest packet; and
determining the next node based on the PIT when the received packet is the response packet.

6. The method of claim 1, wherein the restoring of the routing path includes:
searching the relay candidate buffer for a response packet corresponding to the interest packet when the packet having failed to be relayed is the interest packet, and searching the relay candidate buffer for an interest packet corresponding to the response packet when the packet having failed to be relayed is the response packet;
when the corresponding response packet or interest packet is retrieved, determining a next node to which the packet, having failed to be relayed, will be relayed based on header information of the retrieved packet, and retransmitting the packet; and
removing the retransmitted packet from the relay candidate buffer.

7. The method of claim 6, wherein the restoring of the routing path further includes:
determining a next node to which the interest or response packet, retrieved to correspond to the packet having failed to be relayed, will be relayed based on header information of the packet having failed to be relayed, and retransmitting the corresponding packet; and
removing the retransmitted corresponding packet from the relay candidate buffer.

8. The method of claim 6, wherein the searching of the corresponding response packet or interest packet includes searching for a packet including the same content identifier (ID) as the packet having failed to be relayed in a header.

9. A method of communicating content in a mobile ad-hoc network, the method comprising:
receiving an interest packet for content;
determining whether content corresponding to a content identifier (ID) included in a header of the interest packet is present in a content memory;
when it is determined that the content corresponding to the content ID is not present in the content memory, updating a pending interest table (PIT) based on header information of the interest packet;
updating relay node identification information in the header information of the interest packet with identification information of a current node having received the interest packet, and increasing a value of distance from a requestor;
determining a next node to which the interest packet will be relayed based on a forwarding information base (FIB), and relaying the interest packet; and
when the relay of the interest packet to the next node fails, restoring a routing path by storing the interest packet in a relay candidate buffer and broadcasting the interest packet.

10. The method of claim 9, further comprising, when it is determined that the content corresponding to the content ID included in the header of the interest packet is present in the content memory, generating a response packet including the content present in the content memory and returning the response packet to a node having relayed the interest packet.

11. The method of claim 9, wherein a header of the interest packet includes at least one of requestor identification information, identification information of a relay node having relayed the interest packet, the distance from the requestor, a packet lifetime, a content ID, and a flooding bit.

12. The method of claim 9, wherein each entry of the PIT includes at least one of a content ID, content requestor identification information, identification information of a relay node having relayed the interest packet for requesting the content, information on the distance from the requestor, lifetime information of the entry, and a flooding bit.

13. The method of claim 11, wherein the updating of the PIT based on the header information of the interest packet includes:
when there is no entry having the same requestor identification information and content ID as the interest packet, adding an entry corresponding to the interest packet to the PIT based on the header information of the interest packet; and
when there is an entry having the same requestor identification information and content ID as the interest packet but the distance value stored in the interest packet is smaller than a distance value of the entry in the PIT, updating the entry with the header information of the interest packet.

14. The method of claim 9, wherein the restoring of the routing path includes:
searching the relay candidate buffer for a response packet corresponding to the interest packet having failed to be relayed;
when the corresponding response packet is retrieved, determining a next node to which the interest packet, having failed to be relayed, will be relayed based on header information of the retrieved response packet, and retransmitting the interest packet having failed to be relayed;
determining a next node to which the retrieved response packet will be relayed based on the header information of the interest packet having failed to be relayed, and retransmitting the retrieved response packet; and
removing the retransmitted interest and response packets from the relay candidate buffer.

15. A method of communicating content in a mobile ad-hoc network, the method comprising:
receiving a response packet including content;
storing the content included in the response packet in a content memory together with a content identifier (ID);
updating relay node identification information in header information of the response packet with identification information of a current node, and increasing a value of distance from a requestor;
determining a next node to which the response packet will be relayed based on a pending interest table (PIT), and relaying the response packet; and
when the determination of the next node fails or the relay of the response packet to the next node fails, restoring a routing path by storing the response packet in a relay candidate buffer and broadcasting the response packet.

16. The method of claim 15, wherein the restoring of the routing path includes:
searching the relay candidate buffer for an interest packet corresponding to the response packet having failed to be relayed;
determining a next node to which the response packet, having failed to be relayed, will be relayed based on header information of a retrieved interest packet, and retransmitting the response packet having failed to be relayed;
determining a next node to which the retrieved interest packet will be relayed based on the header information of the response packet having failed to be relayed, and retransmitting the retrieved interest packet; and
removing the retransmitted response and interest packets from the relay candidate buffer.

17. The method of claim 15, further comprising, after the relay of the response packet is finished, removing an entry of an interest packet corresponding to the response packet from the PIT.

18. A communication node included in a mobile ad-hoc network, the communication node comprising:
a wireless transceiver configured to exchange packets with a neighboring node;
a processor; and
a memory comprising instructions that, when executed by the processor; perform operations comprising:
receiving an interest packet for content or a response packet including content from the neighboring node through the wireless transceiver;
determining a next node to which the received packet will be relayed based on a forwarding information base (FIB) or a pending interest table (PIT) stored in the memory to relay the received packet; and
restoring a routing path by storing the received packet in a relay candidate buffer in the memory and broadcasting the received packet through the wireless transceiver, when the relay of the received packet to the next node fails.

19. A communication node included in a mobile ad-hoc network, the communication node comprising:
a wireless transceiver configured to exchange packets with a neighboring node;
a processor; and
a memory comprising instructions that, when executed by the processor; perform operations comprising:
receiving an interest packet for content from the neighboring node through the wireless transceiver;
determining whether content corresponding to a content identifier (ID) included in a header of the interest packet is present in the memory;
updating a pending interest table (PIT) in the memory based on header information of the interest packet, updating relay node identification information in the header information of the interest packet with identification information of the communication node, increasing a value of distance from a requestor, and determining a next node to which the interest packet will be relayed based on a forwarding information base (FIB) in the memory, when it is determined that the content corresponding to the content ID is not present in the memory; and
restoring a routing path by storing the interest packet in a relay candidate buffer in the memory and broadcasting the interest packet, when relay of the interest packet to the determined next node fails.

20. A communication node included in a mobile ad-hoc network, the communication node comprising:
a wireless transceiver configured to exchange packets with a neighboring node;
a processor; and
a memory comprising instructions that, when executed by the processor; perform operations comprising:
receiving a response packet including content from the neighboring node through the wireless transceiver;
storing the content included in the response packet in the memory together with a content identifier (ID);
updating relay node identification information in header information of the response packet with identification information of the communication node and increasing a value of distance from a requestor,
determining a next node to which the response packet will be relayed based on a pending interest table (PIT) in the memory and relaying the response packet; and
restoring a routing path by storing the response packet in a relay candidate buffer in the memory and broadcasting the response packet, when the determination of the next node fails or the relay of the response packet to the determined next node fails.
